(19) United States
(12) Patent Application Publication
(10) Pub. No.: US 2022/0366228 A1
(43) Pub. Date: Nov. 17, 2022

(54) DATA GENERATION APPARATUS, DATA GENERATION METHOD, LEARNING APPARATUS AND RECORDING MEDIUM

(71) Applicant: NEC Corporation, Minato-ku, Tokyo (JP)

(72) Inventor: Makoto Takamoto, Tokyo (JP)

(73) Assignee: NEC Corporation, Minato-ku, Tokyo (JP)

(21) Appl. No.: 17/618,998

(22) PCT Filed: Apr. 27, 2020
(86) PCT No.: PCT/JP2020/017974

§ 371 Date: Dec. 14, 2021

(51) Int. Cl. G06N 3/063; G06V 10/778; G06V 10/774; G06V 10/82

(52) U.S. Cl. CPC G06N 3/063; G06V 10/7792; G06V 10/7747; G06V 10/82

(57) ABSTRACT

A data generation apparatus (2) has: an obtaining unit (21) that obtains real data (D_real); a fake data generating unit (22) that generates fake data (D_fake) that imitates the real data; and a mix data generating unit (23) that generates mix data (D_mix) by mixing the real data and the fake data at a desired mix ratio (a), the mix data generating unit changes the mix ratio that is used to generate a data element of the mix data based on a position of the data element in the mix data.

### TECHNICAL FIELD

The present disclosure relates to a technical field of a data generation apparatus, a data generation method, a learning apparatus and a recording medium.

### BACKGROUND ART

A data generation apparatus using a Generative Adversarial Network (GAN) that is configured to generate a fake data (for example, a fake image) that imitates a real data (for example, a real image) is known as a data generation apparatus. The Generative Adversarial Network includes a Generator that generates the fake data and a Discriminator that discriminates the fake data from the real data. A learning of the Generator is performed so that the Generator is configured to generate the fake data that can deceive the Discriminator and a learning of the Discriminator is performed so that the Discriminator is configured to discriminate the fake data generated by the Generator from the real data.

The Generative Adversarial Network is applied to various technical fields. For example, a Patent Literature 1 discloses an ophthalmic image processing apparatus that obtains a high-resolution image from a low-resolution image by using the Generator (specifically, a generation model used by the Generator) that is learned by using the Generative Adversarial Network.

Note that there are Patent Literatures 2 to 3 and Non-Patent Literatures 1 to 3 as a background art document relating to the present disclosure.

### CITATION LIST

### Patent Literature

Patent Literature 1: JP2020-000678A
Patent Literature 2: JP2019-091440A
Patent Literature 3: JP2019-109563A

### Non-Patent Literature

Non-Patent Literature 1: Hongyi Zhang et al, “mixup: BEYOND EMPERICAL RISK MINIMIZATION”, ICLR (International Conference on Learning Representations) 2018, 2018
Non-Patent Literature 2: Sangdoo Yun et al, “CutMix: Regularization Strategy to Traing Strong Classifiers with Localizable Features”, arxiv, 1905.04899, Aug. 7, 2019
Non-Patent Literature 3: Ishaan Gulrajani et al, “Improved Training of Wasserstein GANs”, arxiv, 1704.00028, Mar. 31, 2017

### SUMMARY

### Technical Problem

The Generative Adversarial Network has such a technical problem that the learning of the Generator and the Discriminator needs enormously much time. Namely, the Generative Adversarial Network has such a technical problem that it is difficult to perform the learning of the Generator and the Discriminator efficiently.

It is an example object of the present disclosure to provide a data generation apparatus, a data generation method and a recording medium that can solve the above described technical problem. By way of example, an example object of the present disclosure is to provide a data generation apparatus, a learning apparatus, a data generation method and a recording medium that is configured to efficiently perform a learning of an apparatus that is configured to perform a learning of a generating unit for generating a fake data and a discriminating unit for discriminating the fake data from a real data.

### Solution to Problem

One example aspect of a data generation apparatus of the present disclosure includes: an obtaining unit that obtains real data; a fake data generating unit that obtains or generates fake data that imitates the real data; and a mix data generating unit that generates mix data by mixing the real data and the fake data at a desired mix ratio, the mix data generating unit changes the mix ratio that is used to generate a data element of the mix data based on a position of the data element in the mix data.

One example aspect of a learning apparatus of the present disclosure includes: an obtaining unit that obtains real data; a fake data generating unit that obtains or generates fake data that imitates the real data; a mix data generating unit that generates mix data by mixing the real data and the fake data at a desired mix ratio; and a discriminating unit that discriminates discrimination target data including the real data, the fake data and the mix data by using a discrimination model, the discriminating unit performs a learning of the discrimination model based on a discriminated result of the discrimination target data by the discriminating unit, the mix data generation unit changes the mix ratio based on a time at which the mix data is generated so that the mix ratio that is used to generate the mix data in a first period that includes a period before a predetermined time elapses from a start of a learning of the generation model and the discrimination model is different from the mix ratio that is used to generate the mix data in a second period that is different from the first period and that includes a period after the predetermined time elapses from the start of the learning of the generation model and the discrimination model.

One example aspect of a data generation method of the present disclosure includes: an obtaining step that obtains real data; a fake data generating step that obtains or generates fake data that imitates the real data; and a mix data generating step that generates mix data by mixing the real data and the fake data at a desired mix ratio, the mix ratio that is used to generate a data element of the mix data changing based on a position of the data element in the mix data in the mix data generation step.

One example aspect of a recording medium of the present disclosure is a recording medium on which a computer program that allows a computer to execute a data generation method is recorded, wherein the data generation method includes: an obtaining step that obtains real data; a fake data generating step that obtains or generates fake data that imitates the real data; and a mix data generating step that generates mix data by mixing the real data and the fake data at a desired mix ratio, the mix ratio that is used to generate a data element of the mix data changing based on a position of the data element in the mix data in the mix data generation step.

### BRIEF DESCRIPTION OF DRAWINGS

FIG. 1 is a block diagram that illustrates a configuration of a data generation apparatus in a present example embodiment.

FIG. 2 is a flowchart that illustrates an entire flow of a learning operation performed by the data generation apparatus in the present example embodiment.

FIG. 3 conceptually illustrates a relationship among a mix image, a real image and a fake image.

FIG. 4 is a graph that illustrates a first specific example of a mix ratio.

FIG. 5 is a planar view that illustrates the mix image generated by using the first specific example of the mix ratio.

FIG. 6 is a graph that illustrates a second specific example of the mix ratio.

FIG. 7 is a planar view that illustrates the mix image generated by using the second specific example of the mix ratio.

FIG. 8 is a graph that illustrates a third specific example of the mix ratio.

FIG. 9 is a planar view that illustrates the mix image generated by using the third specific example of the mix ratio.

FIG. 10 is a graph that illustrates a fourth specific example of the mix ratio.

FIG. 11 is a planar view that illustrates the mix image generated by using the fourth specific example of the mix ratio.

FIG. 12 is a block diagram that illustrates another configuration of the data generation apparatus in the present example embodiment.

### DESCRIPTION OF EXAMPLE EMBODIMENTS

Next, an example embodiment of a data generation apparatus, a data generation method and a recording medium will be described with reference to the drawings.

### (1) Configuration of Data Generation Apparatus 1 in Present Example Embodiment

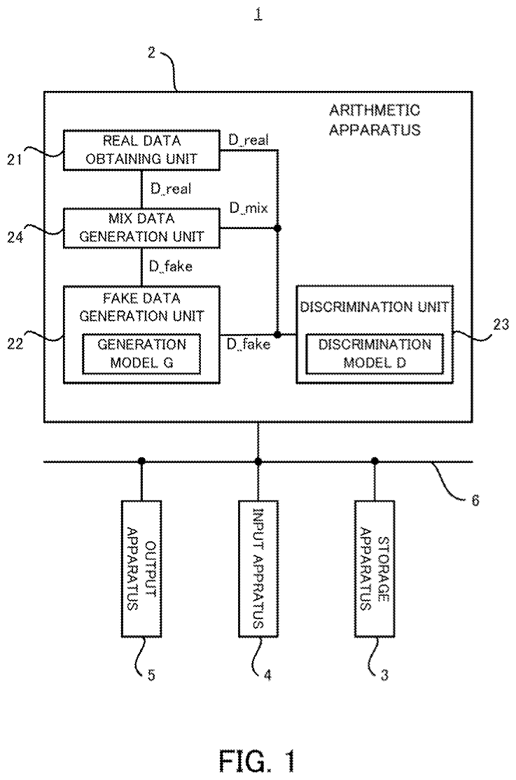

Firstly, with reference to FIG. 1, a configuration of a data generation apparatus 1 in the present example embodiment will be described. FIG. 1 is a block diagram that illustrates the configuration of the data generation apparatus 1 in the present example embodiment.

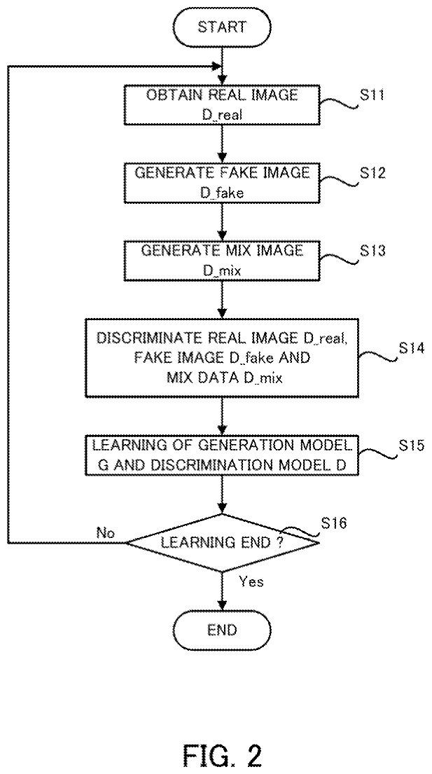

As illustrated in FIG. 2, the data generation apparatus 1 includes an arithmetic apparatus 2 and a storage apparatus 3. Furthermore, the data generation apparatus 1 may include an input apparatus 4 and an output apparatus 5. However, the data generation apparatus 1 may not include at least one of the input apparatus 4 and the output apparatus 5. The arithmetic apparatus 2, the storage apparatus 3, the input apparatus 4 and the output apparatus 5 may be interconnected through a data bus 6.

The arithmetic apparatus 2 includes at least one of a CPU (Central Processing Unit), a GPU (Graphic Processing Unit) and a FPGA (Field Programmable Gate Array), for example. The arithmetic apparatus 2 reads a computer program. For example, the arithmetic apparatus 2 may read a computer program that is stored in the storage apparatus 3. For example, the arithmetic apparatus 2 may read a computer program that is stored in a non-transitory computer-readable recording medium by using a non-illustrated recording medium reading apparatus. The arithmetic apparatus 2 may obtain (namely, download or read) a computer program from a non-illustrated apparatus that is disposed outside the data generation apparatus 1 through a non-illustrated communication apparatus. The arithmetic apparatus 2 executes the read computer program. As a result, a logical functional block for performing an operation that should be performed by the data generation apparatus 1 is implemented in the arithmetic apparatus 2. Namely, the arithmetic apparatus 2 is configured to serve as a controller for implementing the logical block for performing the operation that should be performed by the data generation apparatus 1.

In the present example embodiment, a logical functional block for allowing the data generation apparatus 1 to serve as a data generation apparatus using a Generative Adversarial Network (GAN) is implemented in the arithmetic apparatus 2. FIG. 1 illustrates one example of the logical functional block for allowing the data generation apparatus 1 to serve as the data generation apparatus using a Generative Adversarial Network. As illustrated in FIG. 1, in the arithmetic apparatus 2, a real data obtaining unit 21, a fake data generation unit 22 that is configured to serve as a Generator and a discrimination unit 23 that is configured to serve as a Discriminator are implemented as the logical block. In this case, the data generation apparatus 1 performs a learning operation for performing a learning of each of the fake data generation unit 22 and the discrimination unit 23.

The real data obtaining unit 21 obtains a real image D_real that is usable as leaning data (in other words, training data) for performing a learning of each of the fake data generation unit 22 and the mix data generation unit 23. The real image D_real means an image that should be discriminated by the discrimination unit 23 that it is real (namely, it is not a below described fake image D_fake generated by the fake data generation unit 22). Incidentally, the image shall mean at least one of a still picture and a video in the present example embodiment, when there is no notation. The real image D_real obtained by the real data obtaining unit 21 is inputted to the discrimination unit 23 as a discrimination target image that should be discriminated by the discrimination unit 23.

The fake data generation unit 22 generates the fake image D_fake that imitates the real image D_real. Note that the “fake image D_fake that imitates the real image D_real” means an image that is generated for the purpose of the discrimination unit 23 erroneously discriminating it to be real (namely, the real image D_real). The fake data generation unit 22 generates the fake image D_fake by using a generation model G that is an arithmetic model (in other words, a learnable learning model) that is configured to generate the fake image D_fake, for example. The fake image D_fake generated by the fake data generation unit 22 is inputted to the discrimination unit 23 as the discrimination target image. Note that the fake data generation unit 22 may obtain the fake image D_fake that is already generated, in addition to or instead of generating the fake image D_fake. For example, the e fake image D_fake that is already generated may be stored in the storage apparatus 3 and the fake data generation unit 22 may obtain (namely, read) the fake image D_fake from the storage apparatus 3.

The discrimination unit 23 discriminates the discrimination target image inputted to the discrimination unit 23. Specifically, the discrimination unit 23 discriminates whether the discrimination target image is the real image D_real or not (in other words, the fake image D_fake or not). The discrimination unit 23 discriminates the discrimination target image by using a discrimination model D that is an arithmetic model (in other words, a learnable learning model) that is configured to discriminate the discrimination target image.

A discriminated result of the discrimination target image by the discrimination unit 23 is used for the learning of each of the fake data generation unit 22 and the mix data generation unit 23 (more specifically, a learning of each of the generation model G and the discrimination model D). Specifically, the learning of the generation model G is performed based on the discriminated result of the discrimination target image by the discrimination unit 23 so that the fake data generation unit 22 is configured to generate the fake image D_fake by which the discrimination unit 23 is deceivable (namely, the fake image D_fake that allows the discrimination unit 23 to erroneously discriminate that it is the real image D_fake). On the other hand, the learning of the discrimination model D is performed so that the discrimination unit 23 is configured to discriminate the fake image D_fake from the real image D_real.

As a result of the learning of the generation model G and the discrimination model D, the data generation apparatus 1 can build the generation model G that is configured to generate the fake image D_fake that cannot be easily distinguished from the real image D_real. As a result, the data generation apparatus 1 having the generation model G that is already learned (alternatively, any apparatus using the generation model G that is already learned) is configured to generate the fake image D_fake that cannot be easily distinguished from the real image D_real. The generation model G may be used to generate the image a resolution of which is higher than that of an image inputted to the generation model G, for example. The generation model G may be used to convert (in other words, translate) image inputted to the generation model G into another image, for example.

Especially in the present example embodiment, a mix data generation unit 24 is implemented in the arithmetic apparatus 2 as the logical functional block for allowing the data generation apparatus 1 to serve as the data generation apparatus using the Generative Adversarial Network. The mix data generation unit 24 generates mix data D_mix by mixing the real data D_real and the fake data D_fake. The mix data D_mix is equivalent to an image (namely, the fake image D_fake) that imitates the real data D_real, because the mix data D_mix is different from the real image D_real. Thus, the mix image generation unit 24 may be regarded to generate the fake image D_fake by a method different from that of the fake data generation unit 22. The mix image D_mix generated by the mix data generation unit 24 is inputted to the discrimination unit 23 as the discrimination target image. Therefore, in the present example embodiment, the discrimination unit 24 discriminates whether the mix image D_mix inputted as the discrimination target image is the real image D_real or not (in other words, the fake image D_fake or not).

The storage apparatus 3 is configured to store a desired data. For example, the storage apparatus 3 may temporarily store the computer program that is executed by the arithmetic apparatus 2. The storage apparatus 3 may temporarily store a data that is temporarily used by the arithmetic apparatus 2 when the arithmetic apparatus 2 executes the computer program. The storage apparatus 3 may store a data that is stored for a long term by the data generation apparatus 1. Note that the storage apparatus 3 may include at least one of a RAM (Random Access Memory), a ROM (Read Only Memory), a hard disk apparatus, a magneto-optical disc, a SSD (Solid State Drive) and a disk array apparatus. Namely, the storage apparatus 3 may include a non-transitory recording medium.

The input apparatus 4 is an apparatus that receives an input of an information from an outside of the data generation apparatus 1 to the data generation apparatus 1.

The output apparatus 5 is an apparatus that outputs an information to an outside of the data generation apparatus 1. For example, the output apparatus 5 may output an information relating to the learning operation performed by the data generation apparatus 1. For example, the output apparatus 5 may output an information relating to the generation model G that is learned by the learning operation.

### (2) Flow of Learning Operation Performed by Data Generation Apparatus 1

### (2-1) Entire Flow of Learning Operation

Next, with reference to FIG. 2, an entire flow of the learning operation (namely, the learning operation for performing the learning of the generation model G and the discrimination model D) performed by the data generation apparatus 1 in the present example embodiment will be described. FIG. 2 is a flowchart that illustrates the entire flow of the learning operation performed by the data generation apparatus 1 in the present example embodiment

As illustrated in FIG. 2, the real data obtaining unit 21 obtains the real image D_real (a step S11). For example, the real data obtaining unit 21 may obtain the real image D_real that is stored in the storage apparatus 3. For example, the real data obtaining unit 21 may obtain the real image D_real that is stored in an apparatus that is disposed outside the data generation apparatus 1. For example, the real data obtaining unit 21 may obtain the real image D_real that is generated by an apparatus that is disposed outside the data generation apparatus 1. At least one of the real image D_real that is stored in the apparatus that is disposed outside the data generation apparatus 1 and the real image D_real that is generated by the apparatus that is disposed outside the data generation apparatus 1 may be inputted to the real data obtaining unit through the input apparatus 14. Note that the real data obtaining unit 21 typically obtains a data set including a plurality of real images D_real at the step S11, however, may obtain single real image D_real.

After, before or in parallel with the operation at the step S11, the fake data generation unit 22 generates the fake image D_fake (a step S12). The fake data generation unit 22 generates the fake image D_fake by using the generation model G as described above. The generation model G is an arithmetic model that outputs the fake image D_fake based in an inputted random number when the random number (in other words, a noise or a seed) is inputted thereto. The generation model G is an arithmetic model that includes a Neural Network, however, may be other type of arithmetic model. Note that the fake data generation unit 22 typically generates a plurality of fake images D_fake, however, may generate single fake image D_fake.

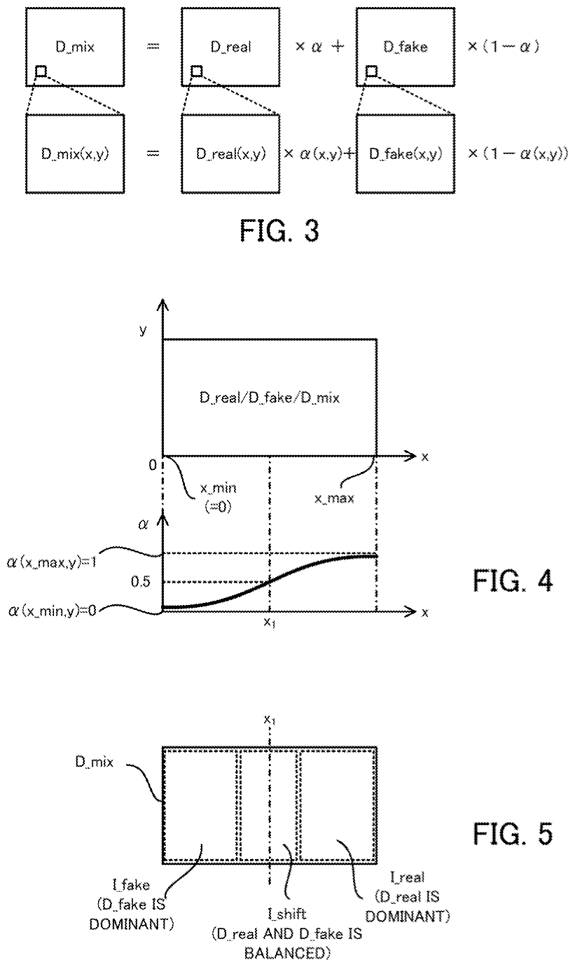

Then, the mix data generation unit 24 generates the mix image D_mix by mixing the real image D_real obtained at the step S11 and the fake image D_fake obtained at the step S12 (a step S13). For example, as illustrated in FIG. 3, the mix data generation unit 24 may generate the mix image D_mix by mixing the real image D_real and the fake image D_fake at a desired mix ratio α (note that the mix ratio α is a numerical value in a range that is equal to or larger than 0 and that is equal to or smaller than 1). Namely, the mix data generation unit 24 may generate the mix image D_mix by using an equation 1 of D_mix=α×D_real+(1−α)×D_fake. More specifically, as illustrated in FIG. 3, when a pixel at a coordinate (x,y) of the mix image D_mix is represented by D_mix(x,y), a pixel at the coordinate (x,y) of the real image D_real is represented by D_real(x,y), a pixel at the coordinate (x,y) of the fake image D_fake is represented by D_fake(x,y), and the mix ratio for generating the pixel D_mix(x,y) is represented by α(x,y), the mix data generation unit 24 may generate the mix image D_mix that includes a plurality of pixels D_mix(x,y) by performing, for all coordinates (x,y), an operation for generating the pixel D_mix(x,y) by using an equation 2 of D_mix(x,y)=α(x,y)×D_real(x,y)+(1−α(x,y))×D_fake(x,y). Note that the mix ratio α may be a parameter that can be freely set by the mix data generation unit 24. Alternatively, the mix ratio α may be a parameter that are set in advance.

Especially in the present example embodiment, the mix data generation unit 24 may change the mix ratio α(x,y) for generating the pixel D_mix(x,y) based on the coordinate (x,y). Namely, the mix data generation unit 24 may change the mix ratio α by which the real image D_real and the fake image D_fake are multiplied based on the coordinate (x,y). In this case, the mix data generation unit 24 may change the mix ratio α by using a function F in which at least one of the coordinate value x and the coordinate value y is an argument. In other words, the mix data generation unit 24 may set the mix ratio α by using the function F in which at least one of the coordinate value x and the coordinate value y is the argument. Namely, the mix data generation unit 24 may set the mix ratio α by using an equation of α(x,y)=F(x,y). Note that the mix ratio α will be described later in detail with reference to FIG. 4 to FIG. 13, and thus, a description thereof omitted here.

Then, the discrimination unit 23 discriminates the description target images that include the real image D_real obtained at the step S11, the fake image D_fake generated at the step S12 and the mix image D_mix generated at the step S13 (a step S14). Specifically, the discrimination unit 24 discriminates (in other words, determines) whether the discrimination target image is the real image D_real or not (in other words, is the fake image D_fake or not).

Then, the arithmetic apparatus 2 performs the learning of each of the generation model G and the discrimination model D based on the discriminated result of the discrimination target image by the discrimination unit 23 at the step S14 (a step S15). The arithmetic apparatus 2 may perform the learning of the generation model G and the discrimination model D by using an existing loss function that is used by a learning of the existing Generative Adversarial Network. For example, the arithmetic apparatus 2 may perform the learning of the generation model G and the discrimination model D by using a loss function for achieving such a goal that the fake image D_fake by which the discrimination unit 23 is deceivable can be generated from the generation model G and the fake image D_fake and the real image D_real can be discriminated by the discrimination model D. In this case, the arithmetic apparatus 2 may perform the learning of the generation model G and the discrimination model D by using a loss function including a gradient penalty term disclosed in the above described Non-Patent Literature 3. Moreover, the arithmetic apparatus 2 may perform the learning of each of the generation model G and the discrimination model D by using a learning algorithm such as a backpropagation and the like. Thus, a detailed description of the learning of the generation model G and the discrimination model D is omitted. Note that the arithmetic apparatus 2 may include a learning unit for performing the learning at the step S15 as a processing block.

Then, the arithmetic apparatus 2 determines whether or not the learning operation illustrated in FIG. 2 ends (a step S16). For example, the arithmetic apparatus 2 may determine that the learning operation ends when an discrimination accuracy of the discrimination target image using the discrimination model D learned at the step S15 is a predetermined accuracy (for example, 50% or a value that is near 50%). For example, the arithmetic apparatus 2 may determine that the learning operation ends when the learning at the step S15 is performed predetermined times or more.

As a result of the determination at the step S16, when it is determined that the learning operation does not end (the step S16: No), the arithmetic apparatus 2 repeat the operation after the step S11. Namely, the real data obtaining unit 21 obtains new real image D_real that is used for the learning operation (the step S11). The fake data generation unit 22 generates new fake image D_fake by using the generation model G learned at the step S15 (the step S12). The mix data generation unit 24 generates new mix image D_mix by mixing the real image D_real newly obtained at the step S11 and the fake image D_fake newly generated at the step S12 (the step S13). The discrimination unit 23 discriminates new description target images that include the real image D_real newly obtained at the step S11, the fake image D_fake newly generated at the step S12 and the mix image D_mix newly generated at the step S13 (a step S14). The arithmetic apparatus 2 performs the learning of each of the generation model G and the discrimination model D based on the discriminated result of new discrimination target image by the discrimination unit 23 at the step S14 (a step S15).

On the other hand, as a result of the determination at the step S16, when it is determined that the learning operation ends (the step S16: Yes), the arithmetic apparatus 2 ends the learning operation illustrated in FIG. 2.

### (2-2) Specific Example of Mix Ration α

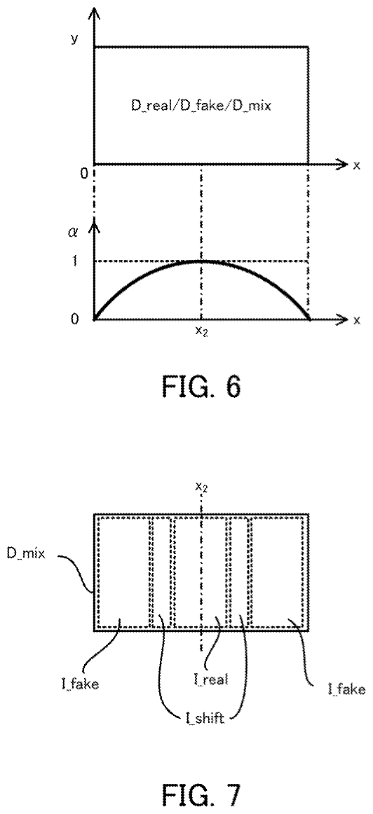

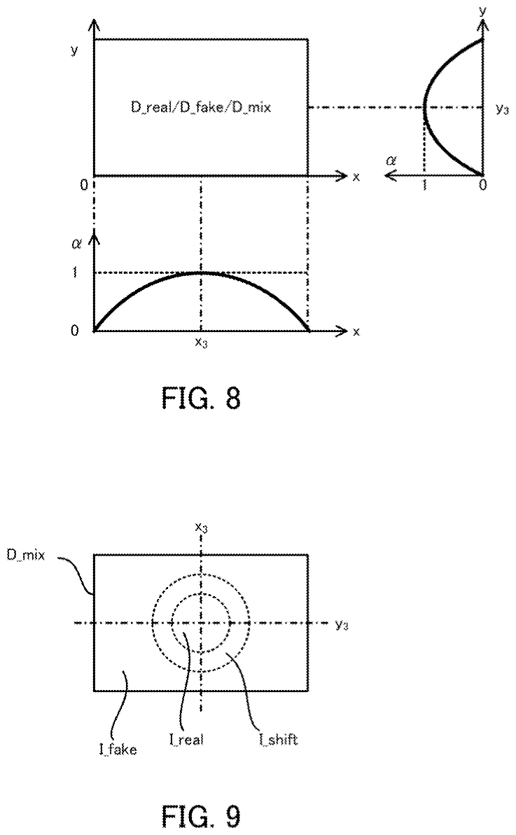

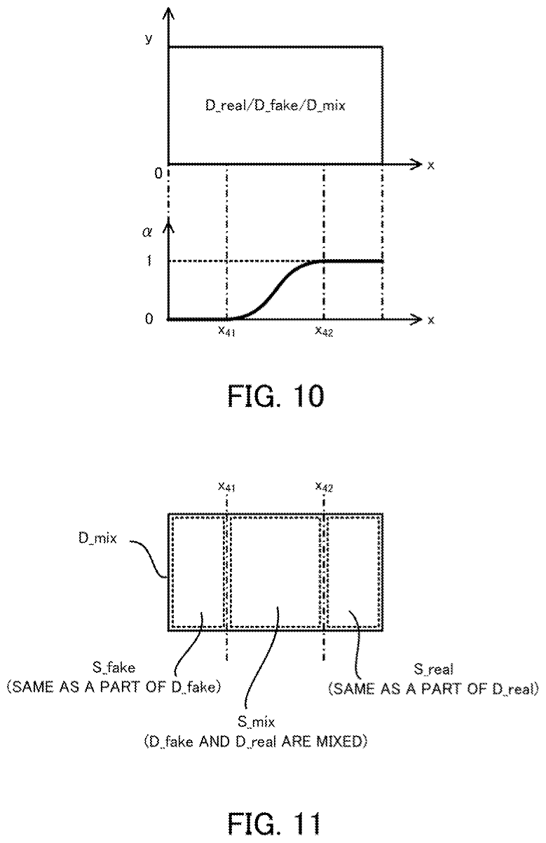

Next, with reference to FIG. 4 to FIG. 13, a specific example of the mix ratio α will be described. FIG. 4 is a graph that illustrates a first specific example of the mix ratio α, FIG. 5 is a planar view that illustrates the mix image D_mix generated by using the first specific example of the mix ratio α, FIG. 6 is a graph that illustrates a second specific example of the mix ratio α (x, y), FIG. 7 is a planar view that illustrates the mix image D_mix generated by using the second specific example of the mix ratio α, FIG. 8 is a graph that illustrates a third specific example of the mix ratio α, FIG. 9 is a planar view that illustrates the mix image D_mix generated by using the third specific example of the mix ratio α, FIG. 10 is a graph that illustrates a fourth specific example of the mix ratio α and FIG. 11 is a planar view that illustrates the mix image D_mix generated by using the fourth specific example of the mix ratio α.

### (2-2-1) First Specific Example of Mix Ration α

As illustrated in FIG. 4, the mix data generation unit 24 may change the mix ratio α in a continuous manner (in other words, smoothly) based on the coordinate value x. Note that a state in which “the mix ratio α changes in the continuous manner” here may mean a state in which the mix ratio α changes in the continuous manner between 0 that is a lower limit value thereof and 1 that is an upper limit value thereof. In this case, the mix ratio α becomes not only 0 that is the lower limit value and 1 that is an upper limit value but also a value that is larger than 0 and is smaller than 1. Thus, when the mix ratio α changes in the continuous manner, the mix ratio α may change, among multiple values, between 0, 1 and at least one value that is larger than 0 and is smaller than 1.

In an example illustrated in FIG. 4, the mix data generation unit 24 changes the mix ratio α in the continuous and monotonical manner based on the coordinate value x so that the mix ratio α becomes larger as the coordinate value x becomes larger. When the mix ratio α changes in the monotonical manner based on the coordinate value x, the mix ratio α changes in the continuous and monotonical manner from the mix ratio α(x_min, y) at a minimum value x_min of the coordinate value x to the mix ratio α(x_max, y) at a maximum value x_max of the coordinate value x. Namely, the mix data generation unit 24 changes the mix ratio α(x,y) for generating the pixel D_mix(x,y) that is sandwiched between the pixel D_mix(x_min, y) and the pixel D_mix(x_max,y) in the X axis direction in the continuous and monotonical manner from the mix ratio α(x_min, y) to the mix ratio α(x_max, y). Note that “the minimum value x_min of the coordinate value x” here means a minimum value of the coordinate value x of the mix image D_mix (namely, a minimum value of the coordinate value x of each of the real image D_real and the fake image D_fake). In the example illustrated in FIG. 4, the minimum value x_min of the coordinate value x is zero. Moreover, “the maximum value x_max of the coordinate value x” here means a maximum value of the coordinate value x of the mix image D_mix (namely, a maximum value of the coordinate value x of each of the real image D_real and the fake image D_fake).

A function using a hyperbolic function is one example of the function F that can change the mix ratio α in this manner. For example, FIG. 4 illustrates an example in which the function F is a function F1(x)=0.5×(1+tanh(x−x₁)). According to the function F1(x), the mix ratio α becomes, between 0 and 1, a value that is smaller than 0.5 when the coordinate value x is smaller than a predetermined value x₁ and is larger than 0.5 when the coordinate value x is larger than the predetermined value x₁.

When the mix image D_mix is generated by using this mix ratio α, the mix image D_mix includes an image part I_fake in which the fake image D_fake is dominant, an image part I_real in which the real image D_real is dominant and an image part I_shift in which the real image D_real and the fake image D_fake are balanced, as illustrated in FIG. 5. Note that the image part I_fake may mean an image part in which a ratio of the fake image D_fake to the mix image D_mix is much larger than a ratio of the real image D_real to the mix image D_mix. Namely, the image part I_fake may mean an image part that is mixed by using the mix ratio α that is larger than an upper limit threshold value (for example, a threshold value that is equal to or larger than 0.8 and that is equal to or smaller than 1) that is much larger than 0.5. The image part I_real may mean an image part in which the ratio of the real image D_real to the mix image D_mix is much larger than the ratio of the fake image D_fake to the mix image D_mix. Namely, the image part I_real may mean an image part that is mixed by using the mix ratio α that is smaller than a lower limit threshold value (for example, a threshold value that is equal to or smaller than 0.2 and that is equal to or larger than 0) that is much smaller than 0.5. The image part I_shift may mean an image part in which a difference between the ratio of the real image D_real to the mix image D_mix and the ratio of the fake image D_fake to the mix image D_mix is smaller than a predetermined difference. Typically, the image part I_shift may mean an image part that is mixed by using the mix ratio α that is smaller than the above described upper limit threshold value and that is larger than the above described lower limit threshold value.

When the mix ratio α changes in the monotonical and continuous manner based on the coordinate value x as illustrated in FIG. 4, the image part I_shift is located between the image part I_real and the image part I_fake in the X axis direction. In this case, it can be said that the image part I_shift serves as an image part that connects the image part I_real and the image part I_fake. Namely, it can be said that the image part I_shift serves as an image part that connects the image part I_real and the image part I_fake relatively smoothly so that a pixel value does not change rapidly between the image part I_real and the image part I_fake.

Note that the mix data generation unit 24 may change the mix ratio α in the continuous manner (in other words, smoothly) based on the coordinate value y, although it is not illustrated in the drawing for convenience of description. The mix data generation unit 24 may change the mix ratio α in the monotonous and continuous manner based on the coordinate value y.

When the mix ratio α changes in the monotonous and continuous manner based on the coordinate value y, the image part I_shift is located between the image part I_real and the image part I_fake in the Y axis direction. For example, the mix data generation unit 24 may set the mix ratio α by using a function F1(y)=0.5×(1+tanh(y−y₁)) as the function F.

Note that a function F1′(x)=0.5×(1+tanh((x−x₁)/Δx)) may be used as the function F instead of the above described function F1(x). In this case, the mix data generation unit 24 can change a width (specifically, a size in the X axis direction) of the image part I_shift by changing a variable number Δx. Specifically, the width of the image part I_shift becomes wider as the variable number Δx becomes larger. Similarly, a function F1′(y)=0.5×(1+tanh((x−y₁)/Δy)) may be used as the function F instead of the above described function F1(y). In this case, the mix data generation unit 24 can change the width (specifically, a size in the Y axis direction) of the image part I_shift by changing a variable number Δy. Moreover, even when the functions F1(x) and F1(y) are not used, the mix data generation unit 24 may set the mix ratio α so that the width of the image part I_shift in at least one of the X axis direction and the Y axis direction is a desired width. Moreover, the mix data generation unit 24 may set the mix ratio α so that a width of at least one of the image part I_real and the image part I_fake is a desired width.

### (2-2-2) Second Specific Example of Mix Ration α

As illustrated in FIG. 6, the mix data generation unit 24 may change the mix ratio α in the continuous manner based on the coordinate value x even in the second specific example, as with the first specific example. However, in the second specific example, the mix data generation unit 24 may not increase or decrease the mix ratio α(x,y) in the monotonous manner over a whole of the coordinate value x. For example, the mix data generation unit 24 may increase the mix ratio α in the monotonous manner based on the coordinate value x when the coordinate value x is a value in a first range and may decrease the mix ratio α(x,y) in the monotonous manner based on the coordinate value x when the coordinate value x is a value in a second range that is different from the first range. In an example illustrated in FIG. 6, the mix data generation unit 24 increases the mix ratio α(x,y) in the monotonous manner based on the coordinate value x when the coordinate value x is smaller than a predetermined value x₂ and decreases the mix ratio α(x,y) in the monotonous manner based on the coordinate value x when the coordinate value x is larger than the predetermined value x₂. In this case, the mix ratio α(x,y) changes around a point at which the coordinate value x is the predetermine value x₂.

A function using an exponential function is one example of the function F that can change the mix ratio α in this manner. For example, FIG. 6 illustrates an example in which the function F is a function F2(x)=e\hat{ }(−(x−x₂)\hat{ }2). Note that a symbol “\hat{ }” in the function F2 represents an exponentiation. Thus, in the present example embodiment, “a\hat{ }b” means a to the b-th power. According to the function F2(x,y), the mix ratio α becomes, between 0 and 1, a value that is 1 as an upper limit value when the coordinate value x is the predetermined value x₂ and that becomes smaller as a difference between the coordinate value x and the predetermined value x₂ becomes larger.

Even when the mix image D_mix is generated by using this mix ratio α, the mix image D_mix includes the image part I_fake, the image part I_real and the image part I_shift, as illustrated in FIG. 7. Moreover, in an area in which the mix ratio α changes in the monotonous manner based on the coordinate value x, the image part I_shift is located between the image part I_real and the image part I_fake in the X axis direction as illustrated in FIG. 7. However, the image part I_shift may not be located between the image part I_real and the image part I_fake. For example, the image part I_shift may be located at an end part (for example, at least one of a right end part and a left end part) of the mix image D_mix.

Note that the mix data generation unit 24 may increase the mix ratio α in the monotonous manner based on the coordinate value y when the coordinate value y is within a third range and may decrease the mix ratio α in the monotonous manner based on the coordinate value y when the coordinate value y is within a fourth range that is different from the third range, although it is not illustrated in the drawing for convenience of description. When the mix ratio α changes in the monotonous manner based on the coordinate value y, the image part I_shift is located between the image part I_real and the image part I_fake in the Y axis direction. For example, the mix data generation unit 24 may set the mix ratio α by using a function F2(y)=e\hat{ }(−(y−y₂)\hat{ }2) as the function F.

### (2-2-3) Third Specific Example of Mix Ration α

As illustrated in FIG. 8, in the third specific example, the mix data generation unit 24 may change the mix ratio α in the continuous manner based on each of the coordinate value x and coordinate value y. Namely, in the third specific example, the mix data generation unit 24 may change the mix ratio α(x,y) by using the function F in which both of the coordinate value x and the coordinate value y are the arguments. Thus, it can be said that the third specific example of the mix ratio α is different from each of the first and second specific examples of the mix ratio α that changes based on the function F in which at least one of the coordinate value x and the coordinate value y is the argument in that it changes based on the function F in which both of the coordinate value x and the coordinate value y are the arguments. Another feature of the third specific example of the mix ratio α may be same as another feature of each of the first and second specific examples of the mix ratio α.

For example, FIG. 8 illustrates an example in which the function F is a function F3(x,y)=e\hat{ }(−(x−x₃)\hat{ }2−(y−y₃)\hat{ }2). According to the function F3(x,y), the mix ratio α(x,y) becomes, between 0 and 1, a value that is 1 as an upper limit value when the coordinate value x is a predetermined value x₃ and the coordinate value y is a predetermined value y₃, that becomes smaller as a difference between the coordinate value x and the predetermined value x₃ becomes larger in a situation where the coordinate value y is fixed and that becomes smaller as a difference between the coordinate value y and the predetermined value y₃ becomes larger in a situation where the coordinate value x is fixed. As a result, as illustrated in FIG. 9, the image part I_real, the image part I_shift that surrounds the image part I_real and the image part I_fake that surrounds the image part I_shift appear in order from a center that is the pixel the coordinate system x of which is the predetermined value x₃ and the coordinate system y of which is the predetermined value y₃.

Note that the function F3(x,y) described with reference to FIG. 8 and FIG. 9 corresponds to a function that is obtained by converting the F2(x) described in the second specific example in which the coordinate value x is the argument into the function in which both of the coordinate value x and the coordinate value y are the arguments. On the other hand, a function F3′(x,y) that is obtained by converting the F1(x) described in the first specific example in which the coordinate value x is the argument into the function in which both of the coordinate value x and the coordinate value y are the arguments may be used for setting the mix ratio α. Specifically, for example, the function F3′(x,y) that is defined so that “the function F3′(x,y)=(i) 0.25×((1+tanh(x−x₃/2)/Δx))*(1+tanh(y−y₃/2)/Δy))—in a case where x<x₃ and y<y₃, (ii) 0.25×((1+tanh(x−3x₃/2)/Δx))*(1+tanh(y−y₃/2)/Δy))—in a case where x>x₃ and y<y₃, (iii) 0.25×((1+tanh(x−x₃/2)/Δx))*(1+tanh(y−3y₃/2)/Δy))—in a case where x<x₃ and y>y₃, and (iv) 0.25×((1+tanh(x−3x₃/2)/Δx))*(1+tanh(y−3y₃/2)/Δy))—in a case where x>x₃ and y>y₃” may be used for setting the mix ratio α. Alternatively, for example, the function F3′(x,y) that is defined so that “the function F3′(x,y)=(i) 0.25×((1+tanh(x−x₃/2))*(1+tanh(y−y₃/2))—in a case where x<x₃ and y<y₃, (ii) 0.25×((1+tanh(x−3x₃/2))*(1+tanh(y−y₃/2))—in a case where x>x₃ and y<y₃, (iii) 0.25×((1+tanh(x−x₃/2))*(1+tanh(y−3y₃/2))—in a case where x<x₃ and y>y₃, and (iv) 0.25×((1+tanh(x−3x₃/2))*(1+tanh(y−3y₃/2))—in a case where x>x₃ and y>y₃” may be used for setting the mix ratio α.

### (2-2-4) Fourth Specific Example of Mix Ration α

As illustrated in FIG. 10, in the fourth specific example, the mix data generation unit 24 may change the mix ratio α in the continuous manner based on the coordinate value x when the coordinate value x is a value in a fifth range and may set the mix ratio α to be a fixed value regardless of the coordinate value x when the coordinate value x is a value in a sixth range that is different from the fifth range. In an example illustrated in FIG. 10, the mix data generation unit 24 (i) fixes the mix ratio α to 0 regardless of the coordinate value x when the coordinate value x is smaller than a predetermined value x₄₁, (i) fixes the mix ratio α to 1 regardless of the coordinate value x when the coordinate value x is larger than a predetermined value x₄₂ (note that x₄₂>x₄₁), and (iii) changes the mix ratio α based on the coordinate system when the coordinate value x is larger than the predetermined value x₄₁ and is smaller than the predetermined value x₄₂. In this case, when the coordinate value x is larger than the predetermined value x₄₁ and is smaller than the predetermined value x₄₂, the mix ratio α may change in the continuous manner from 0 that is a value of the mix ratio α when the coordinate value x is smaller than the predetermined value x₄₁ to 1 that is a value of the mix ratio α when the coordinate value x is larger than the predetermined value x₄₂.

When the mix ratio α is fixed regard less of the coordinate value x, it can be said that at least two mix ratios α(x,y) that correspond to at least two different coordinate values x are the same ratios. For example, in the example illustrated in FIG. 10, the mix ratio α when the coordinate value x is a first value that is smaller than the predetermined value x₄₁ is same as the mix ratio α when the coordinate value x is a second value that is smaller than the predetermined value x₄₁. Thus, it can be said that the fourth specific example of the mix ratio α is different from each of the first to third specific examples of the mix ratio α in which at least two mix ratios α(x,y) corresponding to at least two different coordinate values x are the different ratios in that at least two mix ratios α(x,y) that correspond to at least two different coordinate values x are the same ratios. Another feature of the fourth specific example of the mix ratio α may be same as another feature of each of the first to third specific examples of the mix ratio α.

Incidentally, in the example illustrated in FIG. 10, the mix data generation unit 24 changes the mix ratio α in the monotonous manner based on the coordinate value x (namely, changes it in an aspect described in the first specific example) when the coordinate value x is larger than the predetermined value x₄₁ and is smaller than the predetermined value x₄₂, however, may not change the mix ratio α in the monotonous manner based on the coordinate value x (for example, may change it in an aspect described in the second specific example)

When the mix image D_mix is generated by using this mix ratio α, the mix image D_mix includes an image part S_fake that is same as a part of the fake image D_fake, an image part S_real that is same as a part of the real image D_real and an image part S_mix in which a part of the fake image D_fake and a part of the real image D_real are mixed, as illustrated in FIG. 11. In this case, it can be said that the mix data generation unit 24 fixes the mix ratio α for generating the image part S_fake to a first ratio, fixes the mix ratio α for generating the image part S_real to a second ratio that is different from the first ratio, and changes the mix ratio α for generating the image part S_mix based on the coordinate value x. Note that the image part S_mix may be sandwiched between the image part S_fake and the image part S_real in the X axis direction as illustrated in FIG. 11 or may not be sandwiched.

Note that the mix data generation unit 24 may change the mix ratio α in the continuous manner based on the coordinate value y when the coordinate value y is a value in a seventh range and may set the mix ratio α to be a fixed value regardless of the coordinate value y when the coordinate value x is a value in a eighth range that is different from the seventh range, although it is not illustrated in the drawing for convenience of description.

### (3) Technical Effect of Data Generation Apparatus 1

As described above, in the present example embodiment, not only the real image D_real and the fake image D_fake but also the mix image D_mix that is generated by mixing the real image D_real and the fake image D_fake are inputted to the discrimination unit 23. As a result, the learning of the generation model G and the discrimination model D is also performed based on not only the real image D_real and the fake image D_fake but also the mix image D_mix. As a result, the learning of the generation model G and the discrimination model D is performed more efficiently, compared to a case where the learning of the generation model G and the discrimination model D is performed without using the mix image D_mix.

Specifically, immediately after the learning of the generation model G and the discrimination model D starts, there is a possibility that the fake image D_fake generated by the fake data generation unit 22 is far from the real image D_real (in other words, is very different from the real image D_real). On the other hand, since the mix image D_mix is generated based on the real image D_real, the mix image D_mix possibly include an image that is similar to the real image D_real to some extent. Thus, the generation model G and the discrimination model D can learn both of the fake image D_fake that is far from the real image D_real and the fake image D_fake that is similar to the real image D_real to some extent (namely, the mix image D_mix) at an early phase of the learning of the generation model G and the discrimination model D. On the other hand, when the mix image D_mix is not generated, the generation model G and the discrimination model D can learn only the fake image D_fake that is far from the real image D_real. Thus, in the present example embodiment, since the generation model G and the discrimination model D can learn the fake image D_fake that is similar to the real image D_real to some extent (namely, the mix image D_mix) at the early phase of the learning, a time necessary for the learning of the generation model G and the discrimination model D is reduced. Namely, the learning of the generation model G and the discrimination model D is performed more efficiently.

Moreover, the mix image D_mix corresponds to an intermediate image between the randomly generated fake image D_fake and the real image D_real. Thus, when the mix image D_mix is inputted to the discrimination unit 23, an adverse effect of the randomness of the fake data generation unit 22 on the discrimination unit 23 is reduced, compared to a case where the mix image D_mix is not inputted to the discrimination unit 23. Namely, an adverse effect of the randomness of the fake image D_fake generated by the fake data generation unit 22 on the discrimination unit 23 is reduced. For this reason as well, the learning of the discrimination model D is performed more efficiently. Note that one example of the adverse effect of the randomness of the fake data generation unit 22 on the discrimination unit 23 is such an adverse effect that the fake data generation unit 22 generates new fake image D_fake the feature of which is absolutely different from that of the fake image D_fake previously generated by the fake data generation unit 22 and thus the discrimination unit 23 forgets the previously learned content by newly learning new fake image D_fake, for example.

### (4) Modified Example

### (4-1) First Modified Example

In the above described description, the mix data generation unit 24 changes the mix ratio α for generating the mix image D_mix based on the coordinate (x,y) of the pixel D_mix(x,y) of the mix image D_mix. On the other hand, in a first modified example, the mix data generation unit 24 may change the mix ratio α based on an elapsed time from the start of the learning operation illustrated in FIG. 2 (namely, the learning of the generation model G and the discrimination model D) in addition to or instead of the coordinate (x,y). Namely, the mix data generation unit 24 may change the mix ratio α so that the mix ratio α that is used in a first period in which the elapsed time from the start of the learning operation is a first time is different from the mix ratio α that is used in a second period in which the elapsed time from the start of the learning operation is a second time that is different from the first time.

For example, the mix data generation unit 24 may set the mix ratio α so that a ratio of the image part I_fake in which the fake image D_fake is dominant to the mix image D_mix is equal to or larger than a ratio of the image part I_real in which the real image D_real is dominant to the mix image D_mix before a predetermined time elapses from a start of the learning operation. Namely, the mix data generation unit 24 may set the mix ratio α so that the ratio of the image part I_fake to the mix image D_mix is equal to or larger than the ratio of the image part I_real to the mix image D_mix at the early phase of the learning of the discrimination model D and the generation model G. As one example, the mix data generation unit 24 may set the mix ratio α to be a ratio that is larger than 0 and smaller than 0.5. In this case, the mix image D_mix that is discriminated not to be the real image D_real relatively easily by the discrimination unit 23 is generated at the early phase of the learning. Namely, the mix image D_mix that is discriminated not to be the real image D_real relatively easily by the discrimination unit 23 is inputted to the discrimination unit 23 as the discrimination target image at the early phase of the learning. Thus, the learning of the discrimination model D is performed more efficiently at the early phase of the learning, compared to a case where the mix image D_mix that is so similar to the real image D_real that it is difficult for the discrimination unit 23 to discriminate it from the real image D_real is inputted to the discrimination unit 23 as the discrimination target image.

On the other hand, after the predetermined time elapses from the start of the learning operation, it is expected that the discrimination accuracy of the discrimination unit 23 improves to some extent. Thus, after the predetermined time elapses from the start of the learning operation, the mix data generation unit 24 may set the mix ratio α so that the ratio of the image part I_real to the mix image D_mix is larger than that before the predetermined time elapses from the start of the learning operation. In this case, the mix data generation unit 24 may set the mix ratio α so that the ratio of the image part I_real to the mix image D_mix becomes larger at the elapsed time from the start of the learning operation becomes longer. As one example, the mix data generation unit 24 may gradually increase the mix ratio α from an initial value that is larger than 0 and smaller than 0.5. As a result, the mix data generation unit 24 generates the mix image D_mix that is closer to (namely, more similar to) the real image D_real as the learning of the discrimination model D and the generation model G progresses. Namely, the mix image D_mix (what we call a hard sample) that is difficult to be discriminated not to be the real image D_real by the discrimination unit 23 is inputted to the discrimination unit 23. As a result, the learning of the discrimination model D (furthermore, the learning of the generation model G that is performed adversarially against the learning of the discrimination model D) is performed more efficiently at the early phase of the learning, compared to a case where the mix image D_mix that is difficult to be discriminated not to be the real image D_real by the discrimination unit 23 is not inputted to the discrimination unit 23.

### (4-2) Second Modified Example

In the above described description, the mix data generation unit 24 generates the mix image D_mix by mixing the real image D_real and the fake image D_fake. However, the mix data generation unit 24 may generate the mix image D_mix by mixing two different real images D_real. The mix data generation unit 24 may generate the mix image D_mix by mixing two same real images D_real. The mix data generation unit 24 may generate the mix image D_mix by mixing two different fake images D_fake. The mix data generation unit 24 may generate the mix image D_mix by mixing two same fake images D_fake. The mix data generation unit 24 may generate new mix image D_mix by mixing two same mix images D_mix generated as the fake images D_fake by the mix data generation unit 24. The mix data generation unit 24 may generate new mix image D_mix by mixing two different mix images D_mix generated as the fake images D_fake by the mix data generation unit 24. In any cases, the generated mix image D_mix may be regarded to be equivalent to the data (namely, the fake image D_fake) that imitates the real image D_real, because it is data that is different from the real image D_real.

In the above described description, the mix data generation unit 24 generates the mix image D_mix by mixing the real image D_real and the fake image D_fake generated by the fake data generation unit 22. However, the mix data generation unit 24 may generate new mix image D_mix by mixing the real image D_real and the mix image D_mix generated as the fake image D_fake by the mix data generation unit 24. Even in this case, the fact remains that the generated mix image D_mix is generated by mixing the real image D_real and the fake image D_fake (namely, the mix image D_mix generated as the fake image D_fake).

### (4-3) Third Modified Example

The mix data generation unit 24 may generate the mix image D_mix by using the real image D_real on which a desired image processing is performed. The mix data generation unit 24 may generate the mix image D_mix by using the fake image D_fake on which the desired image processing is performed. In this case, an image processing unit for performing the image processing on at least one of the real image D_real obtained by the real data obtaining unit 21 and the fake image D_fake generated by the fake data generation unit 22 may be implemented in the arithmetic apparatus 2. Note that at least one of a scaling processing, a rotation processing, a noise reduction processing and a HDR (High Dynamic Range) processing is one example of the desired image processing.

### (4-4) Fourth Modified Example

In the above described description, the data generation apparatus 1 performs the learning operation using the image. Namely, in the above described description, the real data obtaining unit 21 obtains the real image D_real as real data, the fake data generation unit 22 generates the fake image D_fake as fake data, the mix data generation unit 24 generates the mix image D_mix as mix data, and the discrimination unit 23 discriminates the discrimination target image including the real image D_real, the fake image D_fake and the mix image D_mix as discrimination target data. However, the data generation apparatus 1 may perform the learning operation using any data that is different from the image. Namely, the real data obtaining unit 21 may obtain any type of real data, the fake data generation unit 22 may generate any type of fake data, the mix data generation unit 24 may generate any type of mix data by mixing the real data and the fake data, and the discrimination unit 23 may discriminate the discrimination target data including the real data, the fake data and the mix data. Even in this case, the mix data generation unit 24 may generate the mix data by using an equation of mix data=mix ratio α×real data+(1−mix ratio α)×fake data. In this case, the mix data generation unit 24 may change the mix ratio α based on a position of each of a plurality of data elements, which are obtained by segmentalizing the mix data, in the mix data. Note that “the position of the data element in the mix data” here may indicate “a position of a data element (for example, the pixel), which is obtained by segmentalizing a target object (for example, the image) represented by the mix data by a desired unit (for example, a unit of the pixel) that is determined based on the target object, in the target object represented by the mix data”.

For example, the data generation apparatus 1 may perform the learning operation using a sound. In this case, the real data obtaining unit 21 may obtain, as the real data, a real sound that should be discriminated by the discrimination unit 23 that it is real (namely, it is not a fake sound generated by the fake data generation unit 22). The fake data generation unit 22 may generate, as the fake data, the fake sound that imitates the real sound. The mix data generation unit 24 may generate, as the mix data, a mix sound by mixing the real sound and the fake sound. For example, the mix data generation unit 24 may generate the mix sound by using an equation of mix sound=mix ratio α×real sound+(1−mix ratio α)×fake sound. In this case, the mix data generation unit 24 may change the mix ratio α based on a time corresponding to each of a plurality of sound elements that are obtained by segmentalizing the mix sound along a time axis (namely, a position of each sound element in the mix sound). In this case, “the position of the data element in the mix data” described above corresponds to a time corresponding to the sound element that is obtained by segmentalizing the sound along the time axis (namely, the sound element that represents the sound at a certain time).

### (4-5) Fifth Modified Example

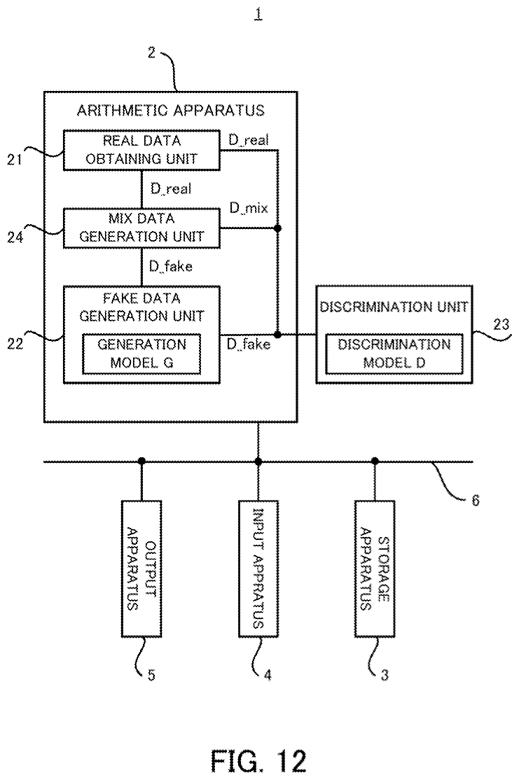

In the above described description, the data generation apparatus 1 (the arithmetic apparatus 2) includes the discrimination unit 23. On the other hand, a data generation apparatus 1a (an arithmetic apparatus 2a) in a fifth modified example may not include the discrimination unit 23, as illustrated in FIG. 12 that illustrates a configuration of the data generation apparatus 1a (the arithmetic apparatus 2a) in the fifth modified example. In this case, the real image D_real obtained by the real data obtaining unit 21, the fake image D_fake generated by the fake data generation unit 22 and the mix image D_mix generated by the mix generation unit 24 may be inputted to the discrimination unit 23 that is disposed outside the data generation apparatus 1a.

### (5) Supplementary Note

At least a part of or whole of the above described example embodiments may be described as the following Supplementary Notes. However, the above described example embodiments are not limited to the following Supplementary Notes.

### (5-1) Supplementary Note 1

A data generation apparatus comprising:

an obtaining unit that obtains real data;

a fake data generating unit that generates fake data that imitates the real data; and

a mix data generating unit that generates mix data by mixing the real data and the fake data at a desired mix ratio,

the mix data generating unit changing the mix ratio that is used to generate a data element of the mix data based on a position of the data element in the mix data.

### (5-2) Supplementary Note 2

The data generation apparatus according to the Supplementary Note 1, wherein

the mix data generating unit changes the mix ratio that is used to generate each of a plurality of data elements of the mix data in a continuous manner by using a function in which the position of the data element in the mix data is an argument.

### (5-3) Supplementary Note 3

The data generation apparatus according to the Supplementary Note 1 or 2, wherein

the mix data generation unit

sets the mix ratio that is used to generate a first data element of the mix data to be a first ratio;

sets the mix ratio that is used to generate a second data element of the mix data that is different from the first data element to be a second ratio that is different from the first ratio; and

changes the mix ratio that is used to generate each of a plurality of third data elements of the mix data, which is between the first and the second data elements, from the first ratio to the second ratio in a continuous manner based on the position of the third data element in the mix data.

### (5-4) Supplementary Note 4

The data generation apparatus according to any one of the Supplementary Notes 1 to 3, wherein

the mix data generating unit changes the mix ratio that is used to generate each of a plurality of data elements that are included in one data part of the mix data in a continuous manner by using a function in which the position of the data element in the mix data is an argument.

### (5-5) Supplementary Note 5

The data generation apparatus according to any one of the Supplementary Notes 1 to 4, wherein

the mix data generation unit

fixes the mix ratio that is used to generate a plurality of data elements included in a first data part of the mix data to be a third ratio;

fixes the mix ratio that is used to generate a plurality of data elements included in a second data part of the mix data that is different from the first data part to be a fourth ratio that is different from the third ratio; and

changes the mix ratio that is used to generate each of a plurality of data elements included in a third part of the mix data, which is between the first and second data parts, from the third ratio to the fourth ratio in a continuous manner based on the position of the data element in the mix data.

### (5-6) Supplementary Note 6

The data generation apparatus according to any one of the Supplementary Notes 1 to 5, wherein

the mix data generating unit changes, among multiple values, the mix ratio that is used to generate each of a plurality of data elements of the mix data by using a function in which the position of the data element in the mix data is an argument.

### (5-7) Supplementary Note 7

The data generation apparatus according to any one of the Supplementary Notes 1 to 6, wherein

the mix data generation unit

sets the mix ratio that is used to generate a first data element of the mix data to be a first ratio;

sets the mix ratio that is used to generate a second data element of the mix data that is different from the first data element to be a second ratio that is different from the first ratio; and

changes, among multiple values from the first ratio to the second ratio, the mix ratio that is used to generate each of a plurality of third data elements of the mix data, which is between the first and the second data elements, based on the position of the third data element in the mix data.

### (5-8) Supplementary Note 8

The data generation apparatus according to any one of the Supplementary Notes 1 to 7, wherein

the mix data generating unit changes, among multiple values, the mix ratio that is used to generate each of a plurality of data elements that are included in one data part of the mix data by using a function in which the position of the data element in the mix data is an argument.

### (5-9) Supplementary Note 9

The data generation apparatus according to any one of the Supplementary Notes 1 to 8, wherein

the mix data generation unit

fixes the mix ratio that is used to generate a plurality of data elements included in a first data part of the mix data to be a third ratio;

fixes the mix ratio that is used to generate a plurality of data elements included in a second data part of the mix data that is different from the first data part to be a fourth ratio that is different from the third ratio; and

changes, among multiple values from the third ratio to the fourth ratio, the mix ratio that is used to generate each of a plurality of data elements included in a third part of the mix data, which is between the first and second data parts, based on the position of the data element in the mix data.

### (5-10) Supplementary Note 10

The data generation apparatus according to any one of the Supplementary Notes 1 to 9, wherein

the mix data generation unit changes the mix ratio so that the mix data includes a fourth data part in which the real data is dominant, a fifth data part in which the fake data is dominant and a sixth data part in which the real data and the fake data are balanced.

### (5-11) Supplementary Note 11

The data generation apparatus according to the Supplementary Note 10, wherein

the mix data generation unit changes the mix ratio so that the sixth data part is located between the fourth data part and the fifth data part.

### (5-12) Supplementary Note 12

The data generation apparatus according to any one of the Supplementary Notes 1 to 11, wherein

the mix data generation unit changes the mix ratio based on a time at which the mix data is generated so that the mix ratio that is used to generate the mix data in a first period is different from the mix ratio that is used to generate the mix data in a second period that is different from the first period.

### (5-13) Supplementary Note 13

The data generation apparatus according to the Supplementary Note 12, wherein

the mix data generation unit

sets the mix ratio in the first period so that a ratio of a fifth data part in which the fake data is dominant to the mix data is equal to or larger than a ratio of a fourth data part in which the real data is dominant to the mix data; and

sets the mix ratio in the second period so that a ratio of the fourth data part to the mix data in the second period is larger than a ratio of the fourth data part to the mix data in the first period.

### (5-14) Supplementary Note 14

The data generation apparatus according to the Supplementary Note 12 or 13 further comprising a discriminating unit that discriminates discrimination target data including the real data, the fake data and the mix data,

the fake data generating unit generating the fake data by using a generation model that is learnable based on a discriminated result of the discrimination target data by the discriminating unit and that is for generating the fake data,

the discriminating unit discriminating the discrimination target data by using a discrimination model that is learnable based on the discriminated result of the discrimination target data by the discriminating unit and that is for discriminating the discrimination target data,

the first period including a period before a predetermined time elapses from a start of a learning of the generation model and the discrimination model,

the second period including a period after the predetermined time elapses from the start of the learning of the generation model and the discrimination model.

### (5-15) Supplementary Note 15

The data generation apparatus according to any one of the Supplementary Notes 1 to 14, wherein

each of the real data, the fake data and the mix data is data relating to an image,

the data element of the mix data includes a pixel of the image,

the position of the data element in the mix data is a position of the pixel in the image.

### (5-16) Supplementary Note 16

The data generation apparatus according to any one of the Supplementary Notes 1 to 15, wherein

the mix data generating unit changes the mix ratio that is used to generate each of a plurality of data elements of the mix data in a discontinuous manner or a stepwise manner by using a function in which the position of the data element in the mix data is an argument.

### (5-17) Supplementary Note 17

The data generation apparatus according to any one of the Supplementary Notes 1 to 16, wherein

the mix data generating unit changes the mix ratio so that the mix ratio changes, on a line that connects a first data element to a second element of the mix data, (i) from a fifth ratio that allows a ratio of the real data to the fake data is 1:0 to a sixth ratio that allows the ratio of the real data to the fake data is 1:1 or (ii) from the sixth ratio to the fifth ratio, or (iii) from a seventh ratio that allows the ratio of the real data to the fake data is 0:1 to the sixth ratio or (iv) from the sixth ratio to the seventh ration.

### (5-18) Supplementary Note 18

18. A learning apparatus comprising:

an obtaining unit that obtains real data;

a fake data generating unit that obtains or generates fake data that imitates the real data;

a mix data generating unit that generates mix data by mixing the real data and the fake data at a desired mix ratio; and

a discriminating unit that discriminates discrimination target data including the real data, the fake data and the mix data by using a discrimination model,

the discriminating unit allowing the discrimination model to be learned based on a discriminated result of the discrimination target data by the discriminating unit,

the mix data generation unit changing the mix ratio based on a time at which the mix data is generated so that the mix ratio that is used to generate the mix data in a first period that includes a period before a predetermined time elapses from a start of a learning of the generation model and the discrimination model is different from the mix ratio that is used to generate the mix data in a second period that is different from the first period and that includes a period after the predetermined time elapses from the start of the learning of the generation model and the discrimination model.

### (5-19) Supplementary Note 19

A data generation method comprising:

an obtaining step that obtains real data;

a fake data generating step that obtains or generates fake data that imitates the real data; and

a mix data generating step that generates mix data by mixing the real data and the fake data at a desired mix ratio,

the mix ratio that is used to generate a data element of the mix data changing based on a position of the data element in the mix data in the mix data generation step.

### (5-20) Supplementary Note 20

A recording medium on which a computer program that allows a computer to execute a data generation method is recorded,

the data generation method comprising:

an obtaining step that obtains real data;

a fake data generating step that obtains or generates fake data that imitates the real data; and

a mix data generating step that generates mix data by mixing the real data and the fake data at a desired mix ratio,

the mix ratio that is used to generate a data element of the mix data changing based on a position of the data element in the mix data in the mix data generation step.

### (5-21) Supplementary Note 21

A computer program that allows a computer to execute a data generation method is recorded,

the data generation method comprising:

an obtaining step that obtains real data;

a fake data generating step that obtains or generates fake data that imitates the real data; and

a mix data generating step that generates mix data by mixing the real data and the fake data at a desired mix ratio,

the mix ratio that is used to generate a data element of the mix data changing based on a position of the data element in the mix data in the mix data generation step.

The present disclosure is allowed to be changed, if desired, without departing from the essence or spirit of the invention which can be read from the claims and the entire specification, and a data generation apparatus, a learning apparatus, a data generation method and a recording medium, which involve such changes, are also intended to be within the technical scope of the present disclosure.

### DESCRIPTION OF REFERENCE CODES

1 data generation apparatus
2 arithmetic apparatus
21 real data obtaining unit
22 fake data generation unit
23 storage apparatus
24 discrimination unit
24 mix data generation unit
G generation model
D discrimination model
D_real real image
D_fake fake image
D_mix mix image

What is claimed is:

1. A data generation apparatus comprising:
at least one memory configured to store instructions; and
at least one processor configured to execute the instructions to:
obtain real data;
a obtain or generates fake data that imitates the real data; and
generate mix data by mixing the real data and the fake data at a desired mix ratio,
the processing being programmed to change the mix ratio that is used to generate a data element of the mix data based on a position of the data element in the mix data.

2. The data generation apparatus according to claim 1, wherein
the at least one processor is configured to execute the instructions to change the mix ratio that is used to generate each of a plurality of data elements of the mix data in a continuous manner by using a function in which the position of the data element in the mix data is an argument.

3. The data generation apparatus according to claim 1, wherein
the at least one processor is configured to execute the instructions to:
sets the mix ratio that is used to generate a first data element of the mix data to be a first ratio;
sets the mix ratio that is used to generate a second data element of the mix data that is different from the first data element to be a second ratio that is different from the first ratio; and
changes the mix ratio that is used to generate each of a plurality of third data elements of the mix data, which is between the first and the second data elements, from the first ratio to the second ratio in a continuous manner based on the position of the third data element in the mix data.

4. The data generation apparatus according to claim 1, wherein
the at least one processor is configured to execute the instructions to changes the mix ratio that is used to generate each of a plurality of data elements that are included in one data part of the mix data in a continuous manner by using a function in which the position of the data element in the mix data is an argument.

5. The data generation apparatus according to claim 1, wherein
the at least one processor is configured to execute the instructions to:
fixes the mix ratio that is used to generate a plurality of data elements included in a first data part of the mix data to be a third ratio;
fixes the mix ratio that is used to generate a plurality of data elements included in a second data part of the mix data that is different from the first data part to be a fourth ratio that is different from the third ratio; and
changes the mix ratio that is used to generate each of a plurality of data elements included in a third part of the mix data, which is between the first and second data parts, from the third ratio to the fourth ratio in a continuous manner based on the position of the data element in the mix data.

6. The data generation apparatus according to claim 1, wherein
the at least one processor is configured to execute the instructions to change, among multiple values, the mix ratio that is used to generate each of a plurality of data elements of the mix data by using a function in which the position of the data element in the mix data is an argument.

7. The data generation apparatus according to claim 1, wherein
the at least one processor is configured to execute the instructions to:
sets the mix ratio that is used to generate a first data element of the mix data to be a first ratio;
sets the mix ratio that is used to generate a second data element of the mix data that is different from the first data element to be a second ratio that is different from the first ratio; and
changes, among multiple values from the first ratio to the second ratio, the mix ratio that is used to generate each of a plurality of third data elements of the mix data, which is between the first and the second data elements, based on the position of the third data element in the mix data.

8. The data generation apparatus according to claim 1, wherein
the at least one processor is configured to execute the instructions to change, among multiple values, the mix ratio that is used to generate each of a plurality of data elements that are included in one data part of the mix data by using a function in which the position of the data element in the mix data is an argument.

9. The data generation apparatus according to any one of claim 1, wherein
the at least one processor is configured to execute the instructions to:
fixes the mix ratio that is used to generate a plurality of data elements included in a first data part of the mix data to be a third ratio;
fixes the mix ratio that is used to generate a plurality of data elements included in a second data part of the mix data that is different from the first data part to be a fourth ratio that is different from the third ratio; and
changes, among multiple values from the third ratio to the fourth ratio, the mix ratio that is used to generate each of a plurality of data elements included in a third part of the mix data, which is between the first and second data parts, based on the position of the data element in the mix data.

10. The data generation apparatus according to any one of claim 1, wherein
the at least one processor is configured to execute the instructions to changes the mix ratio so that the mix data includes a fourth data part in which the real data is dominant, a fifth data part in which the fake data is dominant and a sixth data part in which the real data and the fake data are balanced.

11. The data generation apparatus according to claim 10, wherein
the at least one processor is configured to execute the instructions to change the mix ratio so that the sixth data part is located between the fourth data part and the fifth data part.

12. The data generation apparatus according to claim 1, wherein
the at least one processor is configured to execute the instructions to changes the mix ratio based on a time at which the mix data is generated so that the mix ratio that is used to generate the mix data in a first period is different from the mix ratio that is used to generate the mix data in a second period that is different from the first period.

13. The data generation apparatus according to claim 12, wherein
the at least one processor is configured to execute the instructions to:
set the mix ratio in the first period so that a ratio of a fifth data part in which the fake data is dominant to the mix data is equal to or larger than a ratio of a fourth data part in which the real data is dominant to the mix data; and
set the mix ratio in the second period so that a ratio of the fourth data part to the mix data in the second period is larger than a ratio of the fourth data part to the mix data in the first period.

14. The data generation apparatus according to claim 12, wherein
the at least one processor is configured to execute the instructions to:
discriminates discrimination target data including the real data, the fake data and the mix data,
generate the fake data by using a generation model that is learnable based on a discriminated result of the discrimination target data by the discriminating unit and that is for generating the fake data; and
discriminate the discrimination target data by using a discrimination model that is learnable based on the discriminated result of the discrimination target data and that is for discriminating the discrimination target data,
the first period including a period before a predetermined time elapses from a start of a learning of the generation model and the discrimination model,
the second period including a period after the predetermined time elapses from the start of the learning of the generation model and the discrimination model.

15. The data generation apparatus according to claim 1, wherein
each of the real data, the fake data and the mix data is data relating to an image,
the data element of the mix data includes a pixel of the image,
the position of the data element in the mix data is a position of the pixel in the image.

16. The data generation apparatus according to claim 1, wherein
the at least one processor is configured to execute the instructions to change the mix ratio that is used to generate each of a plurality of data elements of the mix data in a discontinuous manner or a stepwise manner by using a function in which the position of the data element in the mix data is an argument.

17. The data generation apparatus according to claim 1, wherein
the at least one processor is configured to execute the instructions to changes the mix ratio so that the mix ratio changes, on a line that connects a first data element to a second element of the mix data, (i) from a fifth ratio that allows a ratio of the real data to the fake data is 1:0 to a sixth ratio that allows the ratio of the real data to the fake data is 1:1 or (ii) from the sixth ratio to the fifth ratio, or (iii) from a seventh ratio that allows a ratio of the real data to the fake data is 0:1 to the sixth ratio or (iv) from the sixth ratio to the seventh ration.

18. A learning apparatus comprising:
at least one memory configured to store instructions; and
at least one processor configured to execute the instructions to:
obtain real data;
obtain or generates fake data that imitates the real data;
generate mix data by mixing the real data and the fake data at a desired mix ratio; and
discriminate discrimination target data including the real data, the fake data and the mix data by using a discrimination model,
the processor being programmed to allow the discrimination model to be learned based on a discriminated result of the discrimination target data,
the processor being programmed to change the mix ratio based on a time at which the mix data is generated so that the mix ratio that is used to generate the mix data in a first period that includes a period before a predetermined time elapses from a start of a learning of the generation model and the discrimination model is different from the mix ratio that is used to generate the mix data in a second period that is different from the first period and that includes a period after the predetermined time elapses from the start of the learning of the generation model and the discrimination model.

19. A data generation method comprising:
obtaining real data;
obtaining or generating fake data that imitates the real data;
generating mix data by mixing the real data and the fake data at a desired mix ratio; and
changing the mix ratio that is used to generate a data element of the mix data based on a position of the data element in the mix data.

20. (canceled)
